(19) United States
(12) Patent Application Publication
(10) Pub. No.: US 2019/0374058 A1
(43) Pub. Date: Dec. 12, 2019

(54) STEAMER ACCESSORY FOR STEAM-HEATING AND/OR STEAM-COOKING FOOD CONTAINED IN A CONTAINER

(71) Applicant: SEB S.A., ECULLY (FR)

(72) Inventors: Laurent BLOND, Beaune (FR); Laurent GUEGAN, Lornay (FR)

(21) Appl. No.: 16/471,223

(22) PCT Filed: Dec. 18, 2017
(86) PCT No.: PCT/FR2017/053670

§ 371 Date: Jun. 19, 2019

(30) Foreign Application Priority Data
Dec. 20, 2016 (FR) 1662881

(51) Int. Cl. A47J 27/04; A47J 27/00; A47J 36/32

(52) U.S. Cl. CPC A47J 27/04; A47J 2027/043; A47J 36/32; A47J 27/004

(57) ABSTRACT

A steamer accessory for steam-heating and/or steam-cooking food in a container includes a steam generator including a steam production chamber connected to at least one steam distribution outlet provided in a lower part, the steam production chamber including a heating device. The heating device is controlled by a control device including a steam detector arranged to detect a flow of steam escaping through a vent that brings the lower part into communication with an outer part.

This invention concerns the technical field of steam production apparatuses and devices for steam-heating and/or steam-cooking food.

More specifically, this invention concerns steamer accessories for steam-heating and/or steam-cooking food contained in a container.

This invention also concerns apparatuses for steam-heating and/or steam-cooking food, comprising a container associated with a steam production device forming such a steamer accessory.

From the document U.S. Pat. No. 6,530,308 we know of a steamer accessory comprising a steam generator comprising a steam production chamber comprising a heating device, the steam production chamber being connected to at least one steam distribution outlet provided in a lower part of the steam generator. This arrangement allows steam to be injected into a cooking enclosure arranged below the steam generator. The steam production chamber is supplied with water by means of a drop control device. However, this device requires manual action by the user in order to modify the flow of steam during cooking.

One objective of this invention is to propose a steamer accessory that can be used with a container for steam-heating and/or steam-cooking food, and that offers good steam production performance, while limiting steam releases to the outside.

Another objective of this invention is to propose a steamer accessory that can be used with a container for steam-heating and/or steam-cooking food, and that is economical to construct.

Another objective of this invention is to propose a steamer accessory that can be used with a container for steam-heating and/or steam-cooking food, and that is simple to use.

These objectives are achieved with a steamer accessory for steam-heating and/or steam-cooking food contained in a container, the steamer accessory comprising a steam generator comprising a steam production chamber connected to at least one steam distribution outlet provided in a lower part of the steam generator, the steam production chamber comprising a heating device, because the heating device is controlled by a control device comprising a steam detector designed to detect a flow of steam escaping from a vent bringing the lower part of the steam generator into communication with an outer part of the steam generator.

In other words, the said vent forms a conduit or a vent allowing steam to pass from the lower part of the steam generator, intended to be placed over the food, to the outer part of the steam generator. The heating device controlled by the control device makes it possible to reduce the heating power after the steam detector has detected a flow of steam exiting through the said vent. These arrangements make it possible to adapt the steam quantity provided according to the size of the container used and the quantity of food in the container. The steam generator may be used with a container to form an enclosure containing the foot to be heated or cooked. If desired, the steam generator may comprise a support device that can be removed from the steam production chamber, such that the steam production chamber rests on the said support device and the said support device has at least a portion of bearing surface intended to rest on a container. Alternatively, a removable support device may be associated with the steam generator to form the enclosure with the container and the steam generator. Thus, several container sizes can be used with the steamer accessory. The removable support device may in particular have an annular configuration or a U-shaped configuration.

Advantageously, the steam detector extends to the inside of the vent and/or forms a wall portion of the vent. This arrangement is well suited to steam detectors intended for detecting the temperature.

According to an advantageous embodiment, the steam detector is formed by an NTC resistor or by a thermostatic switch.

Advantageously, the vent forms an ascending conduit. This arrangement facilitates the escape of the steam.

Advantageously again, the vent forms a straight conduit. This arrangement also facilitates the escape of the steam.

Advantageously again, the vent forms a conduit without baffles. This arrangement again facilitates the escape of the steam.

Advantageously again, the outer part of the steam generator extends over the lower part of the steam generator. This arrangement simplifies the construction of the steamer accessory.

Advantageously again, the steamer accessory comprises a water reservoir. Such an embodiment is well suited to a household appliance.

Advantageously again, the steamer accessory comprises a water reservoir supplying the steam production chamber with water. This arrangement allows a smaller quantity of water to be heated, which helps obtain steam more quickly. Alternatively, the steam production chamber could comprise the water reservoir. In other words, the steam production chamber then comprises a heating device allowing the water reservoir to be heated as in a boiler, for example.

According to one embodiment, the water reservoir is removable from the steam generator and the steam generator carries the removable water reservoir. This arrangement facilitates the filling of the water reservoir.

Advantageously again, the steamer accessory comprises a water reservoir supplying the steam production chamber with water. This arrangement allows a smaller quantity of water to be heated, which helps obtain steam more quickly. Alternatively, the steam production chamber could comprise the water reservoir. In other words, the heating device then allows the water reservoir to be heated as in a boiler, for example.

According to one embodiment, the water reservoir is removable from the steam generator and the steam generator carries the removable water reservoir. This arrangement facilitates the filling of the water reservoir.

Advantageously again, the steam generator has an annular lower bearing surface. This arrangement permits placing the steam generator on the top edge of a container or of an adapter.

Advantageously then, the said at least one steam distribution outlet is surrounded by the annular lower bearing surface.

Advantageously then, the vent is surrounded by the annular lower bearing surface. This arrangement permits balancing the pressure inside the container closed by the steam generator, while controlling the escape of steam from the container closed by the steam generator.

Advantageously again, the steam generator has a lower wall in which is formed the said at least one steam distribution outlet, and the steam production chamber is arranged in the steam generator away from the lower wall. These arrangements allow having a steam distribution chamber beneath the steam production chamber, which allows more freedom in the arrangement of the steam distribution outlet(s).

Advantageously again, the steam generator has an external side wall and the steam production chamber is arranged in the steam generator away from the external side wall. These arrangements permit limiting the temperature of the external side wall of the steam generator.

Advantageously then, the vent discharges in the external side wall. This arrangement permits increasing the size of the receiving area of the water reservoir when the water reservoir is removable.

These objectives are also achieved with an electric steamer comprising a container to contain the food to be cooked and/or heated, and a cover with a lower face to be positioned on the container, because the cover comprises a steamer accessory according to at least one of the aforementioned characteristics. Thus, the enclosure defined by the cover and the container may first be supplied with steam with a high flow of steam, in order to raise the temperature of food previously placed in the container. The vent makes it possible to evacuate air when the enclosure is being filled with steam. When the food is saturated with steam, the steam escapes through the vent with a higher and higher flow, which can be detected by the steam detector. The heating power of the heating device can then be decreased automatically, which prevents excessive steam exhaust and also makes it possible to cook or heat for a longer time with the same initial water quantity. If desired, the cover may comprise a support device that can be removed from the steam production chamber of the steamer accessory, such that the steam production chamber rests on the said support device and the said support device has at least a portion of bearing surface intended to rest on a container.

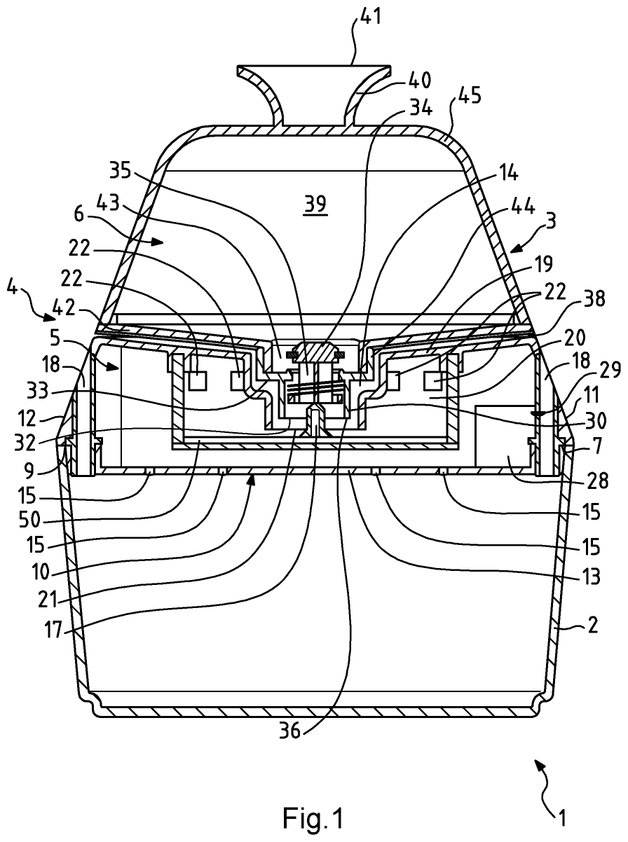

The invention will be more fully understood in consideration of two embodiment examples, which are in no way restrictive, illustrated in the attached FIGS. 1 to 4, in which:

The attached FIG. 1 is a schematic and cross-sectional elevation of a first embodiment example of an electric steamer comprising a steamer accessory according to the invention,

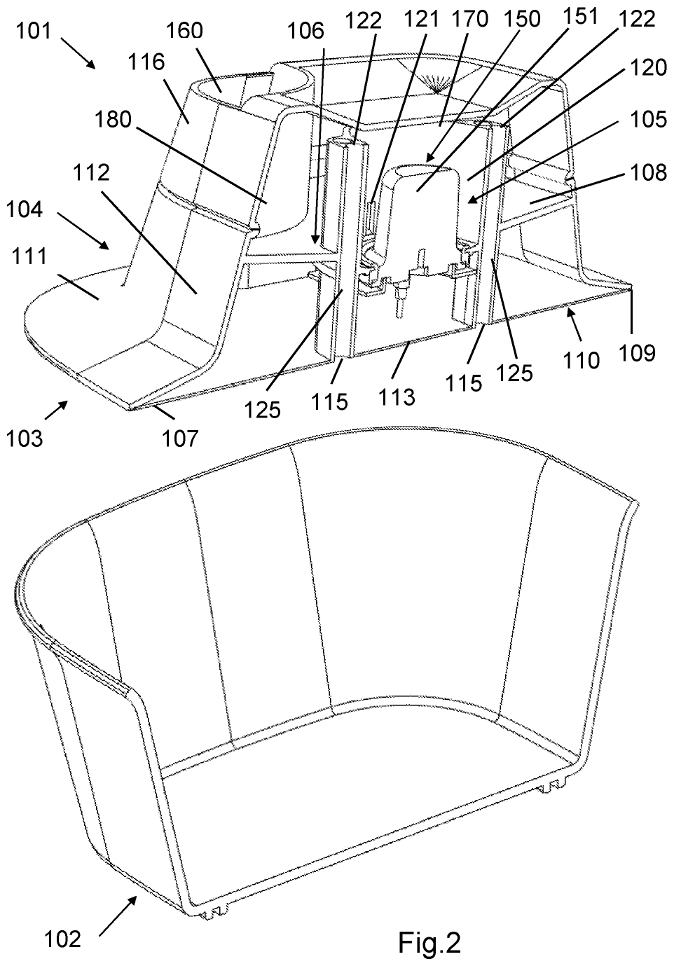

FIG. 2 is an exploded perspective cross-sectional view of a second embodiment example of an electric steamer comprising a steamer accessory according to the invention,

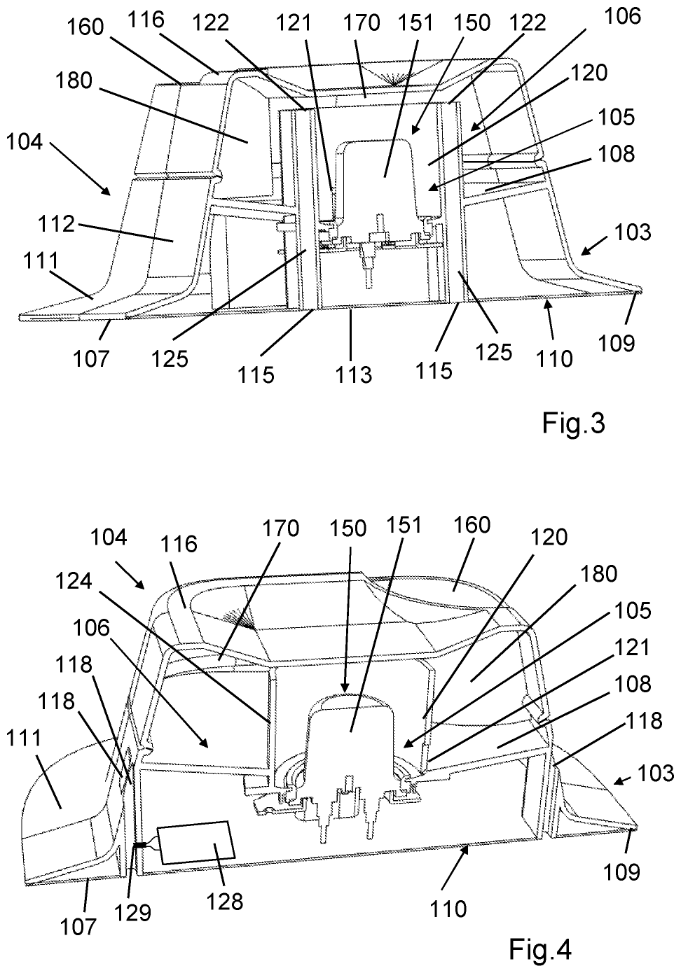

FIG. 3 is a perspective cross-sectional view of the steamer accessory illustrated in FIG. 1, according to another orientation,

FIG. 4 is a perspective cross-sectional view of the steamer accessory illustrated in FIGS. 2 and 3, according to another cross-sectional area.

The electric steamer 1 illustrated schematically in FIG. 1 is an appliance for steam-heating and/or steam-cooking food, comprising a container 2 to contain the food to be heated and/or cooked, and a cover 3 intended to rest on the container 2. For this purpose, the cover 3 has a lower face 7 intended to be positioned on the container 2.

The cover 3 comprises a steamer accessory 4 for steam-heating and/or steam-cooking food in the container 2.

More specifically, in the embodiment example illustrated in FIG. 1, the cover 3 forms a steamer accessory 4 for steam-heating and/or steam-cooking food contained in the container 2. As a variant, the cover 3 may in particular comprise a support device, if desired a removable one, intended to hold the steamer accessory 4, and to rest on the container 2.

The steamer accessory 4 comprises a steam generator 5 and a water reservoir 6. The water reservoir 6 is removable from the steam generator 5 and the steam generator 5 carries the removable water reservoir 6. The steam generator 5 comprises a water inlet 14 supplied with water by the water reservoir 6 arranged on the steam generator 5. The steam generator 5 comprises a steam production chamber 20. The water reservoir 6 supplies the steam production chamber 20 with water. In this regard, the steam production chamber 20 has a water supply inlet 21 supplied with water by the water reservoir 6 arranged on the steam generator 5. The steam production chamber 20 comprises a heating device 50 to transform the water in the steam production chamber 20 into steam. The steam production chamber 20 has at least one steam evacuation outlet 22. The steam production chamber 20 is connected to at least one steam distribution outlet 15 provided in a lower part 10 of the steam generator 5.

More specifically, the steam generator 5 has an annular lower bearing surface 9 intended to rest on the container 2. The water inlet 14 of the steam generator 5 is arranged in an upper face 19 of the steam generator 5. The water inlet 14 forms a funnel. The water inlet 14 discharges to the water supply inlet 21 of the steam production chamber 20. The steam generator 5 has a lower wall 13 in which is formed the said at least one steam distribution outlet 15. As visible in FIG. 1, the said at least one steam distribution outlet 15 is thus surrounded by the annular lower bearing surface 9. The steam generator 5 has at least one vent 18 bringing the lower part 10 of the steam generator 5 into communication with an external part 11 of the steam generator 5 extending above the lower part 10. The said at least one vent 18 is surrounded by the annular lower bearing surface 9. The steam generator 5 has an external side wall 12 extending below the water reservoir 6 arranged on the steam generator 5. The said at least one vent 18 discharges in the external side wall 12.

The heating device 50 is controlled by a control device 28 comprising a steam detector 29 designed to detect a flow of steam escaping through one of the vents 18. The control device 28 makes it possible to reduce the heating power of the heating device 50 when steam has been detected by the steam detector 29.

In the embodiment example illustrated in FIG. 1, the steam detector 29 is arranged in one of the vents 18. The steam detector 29 is advantageously formed by an NTC resistor. The control device 28, represented schematically in FIG. 1, comprises a microprocessor advantageously arranged away from the NTC resistor.

In the embodiment example illustrated in FIG. 1, the heating device 50 is arranged in the bottom of the steam production chamber 20. The heating device 50 may in particular comprise a screen-printed heating element, or a reinforced heating element arranged under a heat diffusion plate and/or in a heat diffusion plate. As a variant, the heating device 50 could in particular be arranged inside the steam production chamber 20.

According to a preferred embodiment, the steam production chamber 20 has at least one steam evacuation outlet 22, positioned higher than the water supply inlet 21, the said at least one steam evacuation outlet 22 communicating with the said at least one steam distribution outlet 15.

In the embodiment example illustrated in FIG. 1, the steam production chamber 20 has several steam exhaust outlets 22 positioned higher than the water supply inlet 21 and communicating with the steam distribution outlets 15. The steam production chamber 20 is arranged in the steam generator 5 away from the lower wall 13, which allows more freedom in the position of the steam distribution outlets 15. The steam production chamber 20 is arranged in the steam generator 5 away from the external side wall 12.

In the embodiment example illustrated in FIG. 1, the steam generator 5 has several vents 18 bringing the lower part 10 of the steam generator 5 into communication with the external part 11 of the steam generator 5. The lower part 10 forms the lower wall 13. The external part 11 forms the external side wall 12.

The water reservoir 6 comprises a drain outlet 32 supplying the steam generator 5 with water.

In the embodiment example illustrated in FIG. 1, the steamer accessory 4 comprises at least one airway 38 bringing the drain outlet 32 into communication with the outside when the water reservoir 6 is arranged on the steam generator 5. As is clearly visible in FIG. 1, the said at least one airway 38 is provided between the water reservoir 6 and the steam generator 5, more specifically between a lower face 33 of the water reservoir 6 and the upper face 19 of the steam generator 5. The water reservoir 6 and/or the steam generator 5 may for this purpose have spacers (not pictured in FIG. 1) to separate the lower face 33 of the water reservoir 6 from the upper face 19 of the steam generator 5. As a variant, the said at least one airway 38 may in particular be provided in the water reservoir 6 and/or in the steam generator 5.

In the embodiment example illustrated in FIG. 1, the drain outlet 32 is arranged in the lower face 33 of the water reservoir 6. The lower part of the water reservoir 6 rests on the upper part of the steam generator 5.

More specifically, the drain outlet 32 extends above the water supply inlet 21 of the steam production chamber 20. The drain outlet 32 presents a valve 34 that can move between a closed position in which the drain outlet 32 is closed and a drainage position in which the drain outlet 32 allows the water to flow out of the water reservoir 6. Preferably, the water reservoir 6 comprises at least one bearing surface 36 extending below the valve 34 positioned in the closed position, to prevent inadvertent actions of the valve 34. According to a preferred embodiment, the valve 34 is surrounded by a conduit 30 extending below the valve 34 positioned in the closed position.

In the embodiment example illustrated in FIG. 1, the steam generator 5 has a lug 17 pushing the valve 34 toward the drainage position when the water reservoir 6 is arranged on the steam generator 5. As visible in FIG. 1, the lug 17 is arranged in the steam production chamber 20. The valve 34 is able to move in a principally vertical direction. The valve 34 is pushed toward the closed position by an elastic return element 35. The elastic return element 35 is advantageously formed by a helical spring. The bearing surface 36 is formed by the drain outlet 32. As a variant, the valve 34 may have a lug pushed by the steam production chamber 20 when the water reservoir 6 is arranged on the steam generator 5.

According to a preferred embodiment, the water reservoir 6 may be positioned on the steam generator 5 according to several angular orientations. In the embodiment example illustrated in FIG. 1, the water reservoir 6 may be positioned on the steam generator 5 without special indexing. More specifically, the water inlet 14 is arranged in the central part of the upper face 19 of the steam generator 5.

According to a preferred embodiment, the water reservoir 6 comprises a gripping device 40. In the embodiment example illustrated in FIG. 1, the gripping device 40 is arranged opposite the drain outlet 32. The gripping device 40 has a bearing surface 41 intended to hold the water reservoir 6 when the water reservoir 6 is positioned upside-down.

The water reservoir 6 may be made in two assembled parts, which can be dismountable if desired, in particular for filling and/or for cleaning. In the embodiment example illustrated in FIG. 1, the lower face 33 of the water reservoir 6 is formed by a base 42 comprising an orifice 43 around which is mounted a stopper 44 presenting the drain outlet 32. The stopper 44 houses the valve 34. A body 45 is mounted on the base 42. The gripping device 40 comes out of the body 45. The body 45 may be assembled such that it may or may not be dismountable from the base 42. As a variant, the gripping device 40 may in particular come out of the base 42, or be connected or fixed on the body 45 or on the base 42. The water reservoir 6 may comprise a filling orifice separate from the drain outlet 32. If desired, the filling orifice may be closed.

The electric steamer 1 and the steamer accessory 4 illustrated in FIG. 1 operate and are used as follows.

The user first fills the water reservoir 6, for example by removing the base 42 from the body 45 after having turned over the water reservoir 6. The user then places the base 42 back on the body 45 and again turns over the water reservoir 6 to position the water reservoir 6 on the steam generator 5. The drain outlet 32 of the water reservoir 6 then extends into the water inlet 14 of the steam generator 5. The valve 34 is pushed toward the drainage position by the steam generator 5 when the water reservoir 6 is arranged on the steam generator 5. The lug 17 then extends inside the conduit 30 and pushes the valve 34 toward the drainage position, such that the water coming from the drain outlet 32 of the water reservoir 6 flows into the water inlet 14 of the steam generator 5 to reach the drain outlet 32 of the water reservoir 6. The water level rises in the steam production chamber 20 until it reaches the drain outlet 32. The water reservoir 6 positioned on the steam generator 5 forms a closed chamber 39 above the drain outlet 32. The water cannot flow out of the water reservoir 6 unless air takes its place. In this regard, the drain outlet 32 communicating with the outside of the steamer accessory 4 through the airway 38 allows air to enter the water reservoir 6, as long as the water level does not reach the drain outlet 32.

The user then turns on the heating device 50. The temperature of the water in the steam production chamber 20 rises until steam is produced. The steam then escapes via the steam evacuation outlets 22 to reach the steam distribution outlets 15 and expand in the container 2 to cook or heat the food in the container 2. The production of steam leads the water level in the steam production chamber 20 to drop below the drain outlet 32, which allows the steam production chamber 20 to be resupplied with water. The water can then drain from the water reservoir 6 via the drain outlet 32, until the water level reaches the drain outlet 32, with air from the outside of the steamer accessory 4 passing through the airway 38 to enter the water reservoir 6 through the drain outlet 32. The food begins to absorb steam to elevate its temperature. Air can escape through the vent(s) 18. When the food is sufficiently saturated with steam, the steam starts to escape through the vents. The escaping steam can then be detected by the steam detector 29 arranged in one of the vents 18. The heating power of the heating device 50 can then be reduced automatically by the control device 28.

The water reservoir 6 supplies water to the steam production chamber 20 by gravity. In other words, the water flows from the water reservoir 6 to supply the steam production chamber 20.

As a variant, the water reservoir 6 does not necessarily have a valve 34. The drain outlet 32 of the water reservoir 6 may in particular be calibrated so that the water flow entering the steam production chamber 20 allows the water in the steam production chamber 20 to vaporize without water overflowing from the steam production chamber 20.

As a variant, the water inlet 14 and the water supply inlet 21 may be combined.

As a variant, the water reservoir 6 may be locked by bayonet closure on the steam generator 5. In this regard, the water reservoir 6 may, for example, comprise tabs provided for fastening by rotation to the steam generator, or vice versa.

As a variant, the steamer accessory 4 may comprise a pump to control the flow of water out of the water reservoir 6 in order to supply the steam production chamber 20. To simplify the electrical connections, the pump may advantageously be arranged in the steam generator 5.

If desired, the steam generator 5 may comprise a support device that can be removed from the steam production chamber 20, such that the steam production chamber 20 rests on the said support device and the said support device has at least a portion of bearing surface intended to rest on a container. The support device may in particular have an annular configuration or a U-shaped configuration. Alternatively, the removable support device may in particular belong to the cover 3.

The electric steamer 101 illustrated schematically in FIG. 2 is an appliance for steam heating and/or steam-cooking food, comprising a container 102 to contain the food to be heated and/or cooked, and a cover 103 intended to rest on the container 102. For this purpose, the cover 103 has a lower face 107 intended to be positioned on the container 102.

The cover 103 comprises a steamer accessory 104 for steam-heating and/or steam-cooking food in the container 102.

More specifically, in the embodiment example illustrated in FIGS. 2 to 4, the cover 103 forms a steamer accessory 104 for steam-heating and/or steam-cooking food in the container 102. As a variant, the cover 103 may in particular comprise a support device, if desired a removable one, intended to hold the steamer accessory 104, and to rest on the container 102.

The steamer accessory 104 comprises a steam generator 105 and a water reservoir 106. The water reservoir 106 communicates with the outside via a filling orifice 160. If desired, the water reservoir 106 may have at least one other filling orifice.

The steam generator 105 comprises a steam production chamber 120. The water reservoir 106 supplies water to the steam production chamber 120 by gravity. In this regard, the water reservoir 106 communicates via a water supply inlet 121 with the steam production chamber 120. If desired, the water reservoir 106 may communicate with the steam production chamber 120 through at least one other water supply inlet.

Preferably, the water reservoir 106 has a bottom 108 discharging towards the water supply inlet 121.

In the embodiment example illustrated in FIGS. 2 to 4, the water reservoir 106 surrounds the steam production chamber 120. In this regard, an annular wall 124, better visible on FIG. 4, surrounds the steam production chamber 120. The water supply inlet 121 is formed in the annular wall 124.

The steam production chamber 120 comprises a heating device 150 to transform the water in the steam production chamber 120 into steam. In the embodiment example illustrated in FIGS. 2 to 4, the heating device 150 comprises a heating pad 151. As a variant, the heating device 150 may in particular comprise a heating element arranged under a heat diffusion plate and/or in a heat diffusion plate forming at least a part of the bottom of the steam production chamber 120.

The steam production chamber 120 is connected to at least one steam distribution outlet 115 provided in a lower part 110 of the steam generator 105. In this regard, the steam production chamber 120 communicates with at least one steam evacuation outlet 122 arranged higher than the water supply inlet 121. The steam production chamber 120 is confined above the steam evacuation outlet(s) 122. The or each steam evacuation outlet 122 communicates via a conduit 125 with the or one of the steam distribution outlet(s) 115.

More specifically, in the embodiment example illustrated in FIGS. 2 to 4, the steam production chamber 120 communicates with the steam evacuation outlet(s) 122 via a steam expansion chamber 170 positioned above the steam production chamber 120. In other words, the said steam expansion chamber has no communication with the outside above the said at least one steam evacuation outlet 122. A separating side wall 180 is arranged between the filling orifice 160 and the steam expansion chamber 170 in order to prevent steam from escaping from the filling orifice 160. In this regard, the separating side wall 180 extends lower than the steam evacuation outlet(s) 122. In other words, the separating side wall 180 extends below the steam evacuation outlet(s) 122. More specifically, the separating side wall 180 extends lower than the water supply inlet 121. As is clearly visible in FIGS. 2 to 4, the separating side wall 180 extends into the water reservoir 106. In other words, the water may reach the two faces of the lower part of the separating side wall 180.

In the embodiment example illustrated in FIGS. 2 to 4, the steam production chamber 120 has several steam evacuation outlets 122 positioned higher than the water supply inlet 121 and communicating via several conduits 125 with the steam distribution outlets 115. More specifically, the conduits 125 are provided in the annular wall 124. Two groups of three conduits 125 are arranged on both sides of the heating pad 151. The conduits 125 are vertical. As a variant, the conduits 125 may be descending without necessarily being vertical. Preferably, the conduits 125 do not have baffles. In other words, the conduits 125 are descending in a continuous manner, without necessarily being straight.

More specifically, the steam generator 105 has an annular lower bearing surface 109 intended to rest on the container 102.

The steam generator 105 has a lower wall 113 in which is/are formed the steam distribution outlet(s) 115. As visible in FIGS. 2 and 3, the steam distribution outlet(s) 115 is/are thus surrounded by the annular lower bearing surface 109. The steam production chamber 120 is arranged in the steam generator 105 away from the lower wall 113, which allows more freedom in the position of the steam distribution outlets 115.

The steam generator 105 has at least one vent 118 bringing the lower part 110 of the steam generator 105 into communication with an external part 111 of the steam generator 105 extending above the lower part 110. The said at least one vent 118 is surrounded by the annular lower bearing surface 109.

The heating device 150 is controlled by a control device 128 comprising a steam detector 129 designed to detect a flow of steam escaping through one of the vents 118. The control device 128 makes it possible to reduce the heating power of the heating device 150 when steam has been detected by the steam detector 129.

The steam generator 105 has an external side wall 112. The bottom 108 of the water reservoir 106 connects the external side wall 112 to the annular wall 124. The steam production chamber 120 is arranged in the steam generator 105 away from the external side wall 112. The said at least one vent 118 discharges in the external side wall 112.

In the embodiment example illustrated in FIGS. 2 to 4, the steam generator 105 has several vents 118 bringing the lower part 110 of the steam generator 105 into communication with the external part 111 of the steam generator 105. The lower part 110 forms the lower wall 113. The external part 111 forms the external side wall 112. Two groups of three vents 118 are positioned on both sides of the water reservoir 106 surrounding the steam production chamber 120.

In the embodiment example illustrated in FIGS. 2 to 4, the steam detector 129 is arranged in one of the vents 118. The steam detector 129 is advantageously formed by an NTC resistor. The control device 128, represented schematically in FIG. 4, comprises a microprocessor advantageously arranged away from the NTC resistor.

The steamer accessory 104 has a top wall 116 advantageously made of transparent or translucent material. The top wall 116 is assembled with the external side wall 112, for example by clipping, bonding, overmoulding, screwing or welding. The top wall 116 forms a part of the water reservoir 106. The separating side wall 180 comes out of the top wall 116. The top wall 116 forms the upper part of the steam expansion chamber 170.

The electric steamer 101 illustrated in FIG. 2 and the steamer accessory 104 illustrated in FIGS. 2 to 4 operate and are used as follows.

The user places the steamer accessory 104 on the container 102 after having placed the food in the container 102. The user fills the water reservoir 106 through the filling orifice 160. The water flows through the water supply inlet 121 into the steam production chamber 120. Preferably, the user fills the water reservoir 106 to a level sufficiently lower than the steam evacuation outlets 122, in order to prevent the water from reaching the steam evacuation outlets 122 and flowing through the conduits 125. The user then turns on the heating device 150. The temperature of the water in the steam production chamber 120 rises until steam is produced. The steam rises from the steam production chamber 120 to reach the steam expansion chamber 170. The steam is then confined by the top wall 116, by the separating side wall 180 and by the water in the water reservoir 106. The steam then escapes via the steam evacuation outlets 122 to reach the steam distribution outlets 115 by descending through the conduits 125. The steam exiting the steam distribution outlets 115 spreads through the container 102. The air above the food can escape through the vents 118. When the food is saturated with steam, the steam also escapes through the vents 118. The escaping steam can then be detected by the steam detector 129 arranged in one of the vents 118. The heating power of the heating device 150 can thus be reduced automatically by the control device 128.

If desired, the steam production chamber 20, 120 may comprise several heating devices. The control device 28, 128 can thus cut the power to at least one of the heating devices in order to reduce the heating power. The steam detector 29, 129 and the control device may then, for example, be formed by a thermostatic switch cutting the power to at least one of the heating devices when the temperature detected exceeds a certain temperature.

If desired, the steam generator 105 may comprise a support device that can be removed from the steam production chamber 120, such that the steam production chamber 120 rests on the said support device and the said support device has at least a portion of bearing surface intended to rest on a container. The support device may, in particular, have an annular configuration or a U-shaped configuration. Alternatively, the removable support device may in particular belong to the cover 103.

As a variant, the steam detector 29; 129 is not necessarily formed by a temperature sensor such as, for example, an NTC resistor or a thermostatic switch, but may be of any type, in particular a flow sensor or a moisture sensor. The heating power of the heating device 50; 150 may be adjusted by electronic means.

The heating power of the heating device 50; 150 may be varied by alternating heating periods at full power and shutdown periods. However, a simple switch between an initial power and a reduced power may suffice.

In the illustrated embodiment examples, the steam detector 29; 129 extends inside the vent 18; 118. As a variant, the steam detector 29; 129 could form a wall portion of the vent 18; 118, in particular when the detector is formed by a thermostatic switch.

In the embodiment examples illustrated, the vent 18; 118 forms an ascending straight conduit. As a variant, the vent could form a conduit with at least one baffle.

This invention is in no way limited to the embodiment examples described and their variants, but encompasses many modifications in the context of the claims.

1. Steamer accessory for steam-heating and/or steam-cooking food contained in a container, the steamer accessory comprising a steam generator comprising a steam production chamber connected to at least one steam distribution outlet provided in a lower part of the steam generator, the steam production chamber comprising a heating device, wherein the heating device is controlled by a control device comprising a steam detector adapted to detect a flow of steam escaping from a vent bringing the lower part of the steam generator into communication with an outer part of the steam generator.

2. The steamer accessory according to claim 1, wherein the steam detector extends inside the vent and/or forms a wall portion of the vent.

3. The steamer accessory according to claim 1, wherein the steam detector is formed by an NTC resistor or by a thermostatic switch.

4. The steamer accessory according to claim 1, wherein the vent forms an ascending conduit.

5. The steamer accessory according to claim 1, wherein the vent forms a straight conduit.

6. The steamer accessory according to claim 1, wherein the vent forms a conduit without baffles.

7. The steamer accessory according to claim 1, wherein the outer part of the steam generator extends above the lower part of the steam generator.

8. The steamer accessory according to claim 1, further comprising a water reservoir.

9. The steamer accessory according to claim 8, wherein the water reservoir supplies the steam production chamber with water.

10. The steamer accessory according to claim 9, wherein the water reservoir is removable from the steam generator and wherein the steam generator carries the removable water reservoir.

11. The steamer accessory according to claim 1, wherein the steam generator has an annular lower bearing surface.

12. The steamer accessory according to claim 1, wherein the steam generator has an annular lower bearing surface intended to rest on the container.

13. The steamer accessory according to claim 1, wherein the at least one steam distribution outlet is surrounded by the annular lower bearing surface.

14. The steamer accessory according to claim 11, wherein the vent is surrounded by the annular lower bearing surface.

15. The steamer accessory according to claim 1, wherein the steam generator has a lower wall in which is formed the at least one steam distribution outlet and wherein the steam production chamber is arranged in the steam generator away from the lower wall.

16. The steamer accessory according to claim 1, wherein the steam generator has an external side wall and wherein the steam production chamber is arranged in the steam generator away from the external side wall.

17. The steamer accessory according to claim 16, wherein the vent discharges in the external side wall.

18. Electric steamer, comprising a container to contain the food to be heated and/or cooked, and a cover with a lower face intended to be positioned on the container, wherein the cover comprises a steamer accessory according to claim 1.
